(19) United States
(12) Patent Application Publication
(10) Pub. No.: US 2024/0097340 A1
(43) Pub. Date: Mar. 21, 2024

(54) Electronic Devices with Wireless Board-to-Board Connectors

(71) Applicant: Apple Inc., Cupertino, CA (US)

(72) Inventors: Thuy Nguyen, San Jose, CA (US); Behzad Biglarbegian, San Jose, CA (US)

(21) Appl. No.: 18/463,262

(22) Filed: Sep. 7, 2023

Related U.S. Application Data
(60) Provisional application No. 63/407,622, filed on Sep. 17, 2022.

(51) Int. Cl. H01Q 9/04; H01Q 1/24; H01Q 1/42

(52) U.S. Cl. CPC H01Q 9/0485; H01Q 1/241; H01Q 1/422

(57) ABSTRACT

An electronic device may include baseband circuitry coupled to antennas over a communication path that includes signal paths on a first substrate, a second substrate, and a third substrate. The antennas may be disposed on the third substrate. A wireless connector may couple the paths on the third substrate to the paths on the second substrate. The wireless connector may include a first transceiver and first antenna on the third substrate and a second transceiver and second antenna on the second substrate. The wireless connector may include one or more dielectric layers disposed between the first antenna and the second antenna. The layers may form a smooth impedance transition between the first antenna and the second antenna. The layers may include one or two angled layers that redirect wireless signals between the first and second antennas to allow the first and second substrates to be offset within the device.

This application claims the benefit of U.S. Provisional Patent Application No. 63/407,622, filed Sep. 17, 2022, which is hereby incorporated by reference herein in its entirety.

### FIELD

100011 This disclosure relates generally to wireless communications, including wireless communications performed by electronic devices.

### BACKGROUND

Electronic devices such as portable computers and cellular telephones are often provided with wireless communications capabilities. To satisfy consumer demand for small form factor wireless devices, manufacturers are continually striving to implement wireless communications circuitry using compact structures. However, it can be challenging to provide wireless communications circuitry that still exhibits satisfactory performance when implemented using compact structures.

### SUMMARY

An electronic device may include wireless circuitry. The wireless circuitry may include baseband circuitry connected to one or more antennas over a communication path. The communication path may convey wireless communications data. The communication path may include signal paths on a first substrate (e.g., a main logic board), a second substrate (e.g., a flexible printed circuit), and a third substrate (e.g., a substrate of an antenna module). The one or more antennas may be disposed on the third substrate. The signal paths may include radio-frequency transmission line paths, intermediate frequency transmission line paths, and/or baseband paths.

A wireless connector may be used to couple the signal paths on the third substrate to the signal paths on the second substrate. The wireless connector may include a first transceiver coupled to the signal paths on the third substrate, a second transceiver coupled to the signal paths on the second substrate, at least a first antenna on the third substrate and coupled to the first transceiver, and at least a second antenna on the second substrate and coupled to the second transceiver. The first and second antennas may transmit and receive wireless signals that include the wireless communications data from the signal paths. The wireless signals may be at relatively high frequencies such as millimeter wave and/or sub-THz frequencies to maximize data rate.

The wireless connector may include one or more dielectric matching layers disposed between the first antenna and the second antenna. The dielectric matching layers may have dielectric constants that configure the dielectric matching layers to form a smooth impedance transition for the wireless signals between the first antenna and the second antenna. This may allow the wireless connector to exhibit minimal signal reflection, minimal insertion loss, maximum bandwidth, and maximum mechanical reliability relative to contact-based connectors. The dielectric matching layers may include one or two angled layers. The angled layers may have angled surfaces that serve to redirect the wireless signals between the first and second antennas. This may allow the first and second substrates to be offset in the electronic device, thereby accommodating the presence of other device components.

An aspect of the disclosure provides an electronic device. The electronic device can include a first substrate having a first signal trace. The electronic device can include a second substrate having a second signal trace. The electronic device can include a wireless connector that communicably couples the first signal trace to the second signal trace, the wireless connector including a first antenna on the first substrate, a second antenna on the second substrate, and one or more dielectric matching layers disposed between the first antenna and the second antenna.

An aspect of the disclosure provides an electronic device. The electronic device can include a first printed circuit board having a first signal path. The electronic device can include a first transceiver on the first printed circuit board and connected to the first signal path. The electronic device can include a second printed circuit board having a second signal path. The electronic device can include a second transceiver on the second printed circuit board and connected to the second signal path. The electronic device can include a first antenna connected to the first transceiver, the first antenna being disposed on the first printed circuit. The electronic device can include a second antenna connected to the second transceiver, the second antenna being disposed on the second printed circuit board and being laterally offset with respect to the first antenna. The electronic device can include a dielectric layer overlapping the first antenna, wherein the dielectric layer has a first surface facing the first printed circuit board and a second surface opposite the first surface, that second surface being non-parallel with respect to the first surface.

An aspect of the disclosure provides an electronic device. The electronic device can include a dielectric cover layer. The electronic device can include a substrate having a first signal path. The electronic device can include a phased antenna array on the substrate, connected to the first signal path, and configured to radiate through the dielectric cover layer. The electronic device can include a flexible printed circuit having a second signal path. The electronic device can include a wireless connector having a first transceiver on the substrate and coupled to the first signal path, a first antenna coupled to the first transceiver, a second transceiver on the flexible printed circuit and coupled to the second signal path, and a second antenna coupled to the second transceiver, the first antenna and the second antenna being configured to wirelessly convey data between the first signal path and the second signal path.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a diagram showing how multiple antennas may be integrated into an illustrative phased antenna array in accordance with some embodiments.

FIG. 4 is a diagram of a communication path for antennas in an electronic device that is distributed across multiple substrates and that includes a wireless connector between substrates in accordance with some embodiments.

FIG. 5 is a schematic diagram of an illustrative wireless connector for a communication path in accordance with some embodiments.

FIG. 6 is a side view of an illustrative wireless connector having aligned antennas in accordance with some embodiments.

FIG. 7 is a side view of an illustrative wireless connector having offset antennas in accordance with some embodiments.

### DETAILED DESCRIPTION

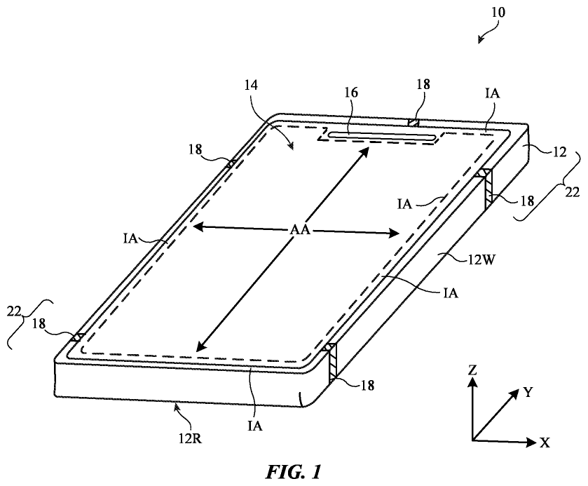

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device, or other wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12 W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12 W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is merely illustrative.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

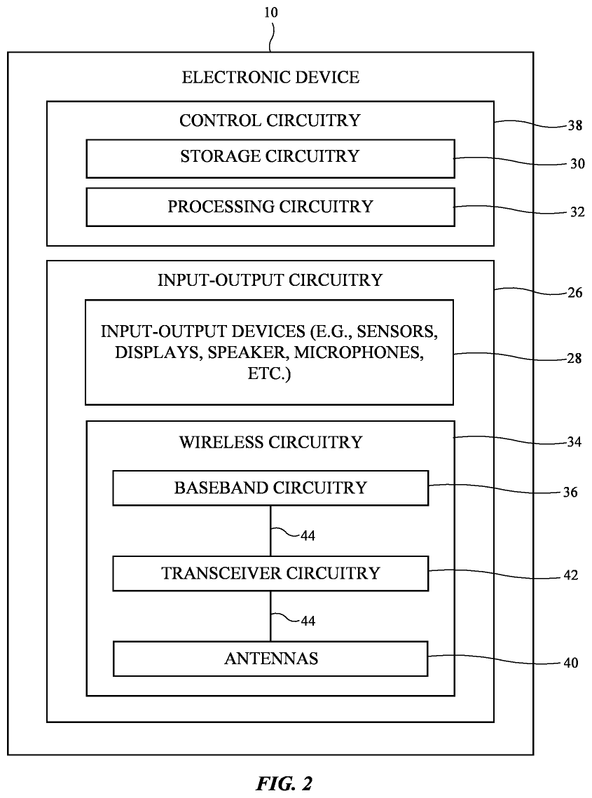

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external communications equipment, control circuitry 12 may be used in implementing communications protocols. Communications protocols that may be implemented using control circuitry 12 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol. Radio-frequency signals conveyed using a cellular telephone protocol may sometimes be referred to herein as cellular telephone signals.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals using one or more antennas 40. Wireless circuitry 34 may include baseband circuitry such as baseband circuitry 36 (e.g., one or more baseband processors or other circuitry that operates at baseband). Baseband circuitry 36 may be coupled to antenna(s) 40 over communication path 44. Radio-frequency (RF) transceiver circuitry such as transceiver circuitry 42 may be disposed on communication path 44 between baseband circuitry 36 and antenna(s) 40. Transceiver circuitry 42 may include one or more transmitters and one or more receivers (e.g., integrated into one or more radios).

The transmitter(s) may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40.

The receiver(s) may include demodulation circuitry, mixer circuitry for down-converting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of transceiver circuitry 42 may be mounted onto a single substrate or integrated into a single integrated circuit, chip, package, or system-on-chip (SOC) or may be distributed between multiple substrates, integrated circuits, chips, packages, or SOCs.

Transceiver circuitry 42 may handle the transmission and/or reception of radio-frequency signals within corresponding frequency bands at radio frequencies (sometimes referred to herein as communications bands or simply as “bands”). The frequency bands handled by transceiver circuitry 42 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, 6G bands between around 100 GHz and 1000 GHz (e.g., sub-THz or THz bands, sometimes also referred to as THF bands), other centimeter or millimeter wave frequency bands between 10-300 GHz, near-field communications frequency bands (e.g., at 13.56 MHz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards external communications equipment).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Baseband circuitry 36 may be coupled to one or more antennas 40 over one or more communication paths 44. Communication path 44 may include multiple signal paths. For example, communication path 44 may include one or more baseband paths (e.g., signal paths that convey baseband signals) coupled between baseband circuitry 36 and transceiver circuitry 42. Communication path 44 may also include one or more radio-frequency transmission line paths that couple transceiver circuitry 42 to antenna(s) 40 (e.g., signal paths that convey radio-frequency signals at the resonant frequencies of antenna(s) 40, at which the antenna(s) transmit and receive signals, and/or signal paths that convey intermediate frequency signals at frequencies above baseband but lower than the resonant frequencies of antenna(s) 40). The radio-frequency transmission line paths may be coupled to antenna feeds (e.g., positive and ground antenna feed terminals) on antenna(s) 40.

If desired, transceiver circuitry 42 may include first mixers or upconverters that up-convert baseband signals from the baseband paths to intermediate frequency signals on the radio-frequency transmission line paths in communication path 44. Transceiver circuitry 42 may then include second mixers or upconverters that up-convert the intermediate frequency signals to the radio-frequency signals that are radiated by antenna(s) 40 (e.g., radio-frequency transmission line paths in communication path 44 may separate different stages of mixers/up-converters in transceiver circuitry 42). Similarly, transceiver circuitry 42 may include third mixers (downconverters) that down-convert radio-frequency signals received by antenna(s) 40 to intermediate frequency signals on the radio-frequency transmission line paths in communication path 44. Transceiver circuitry 42 may then include fourth mixers (downconverters) that down-convert the intermediate frequency signals to baseband signals that are provided to baseband circuitry 36 over the baseband paths in communication path 44 (e.g., radio-frequency transmission line paths in communication path 44 may separate different stages of mixers/down-converters in transceiver circuitry 42). Use of intermediate frequency signals may help to minimize signal attenuation as signals are distributed through communication path 44.

The radio-frequency transmission line paths in communication path 44 may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission line paths may be integrated into rigid and/or flexible printed circuit boards if desired. If desired, radio-frequency front end (RFFE) modules may be interposed on one or more the radio-frequency transmission line paths. The radio-frequency front end modules may include substrates, integrated circuits, chips, or packages that are separate from transceiver circuitry 42 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission line paths.

The example of FIG. 2 is illustrative and non-limiting. While control circuitry 38 is shown separately from wireless circuitry 34 in the example of FIG. 2 for the sake of clarity, wireless circuitry 34 may include processing circuitry (e.g., one or more processors) that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband circuitry that forms part of baseband circuitry 36 (e.g., one or more baseband processors), digital control circuitry, analog control circuitry, and/or other control circuitry that forms part of transceiver circuitry 42. The baseband circuitry may, for example, access a communication protocol stack on control circuitry 38 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34.

Wireless circuitry 34 may convey higher frequency signals over antennas 40 (e.g., mm/cm wave signals or sub-THz signals) to maximize the data rate with which wireless circuitry 34 conveys wireless communications data. However, signals at higher frequencies are subject to more attenuation than lower frequencies. To mitigate this attenuation, two or more antennas 40 may be integrated into a phased antenna array.

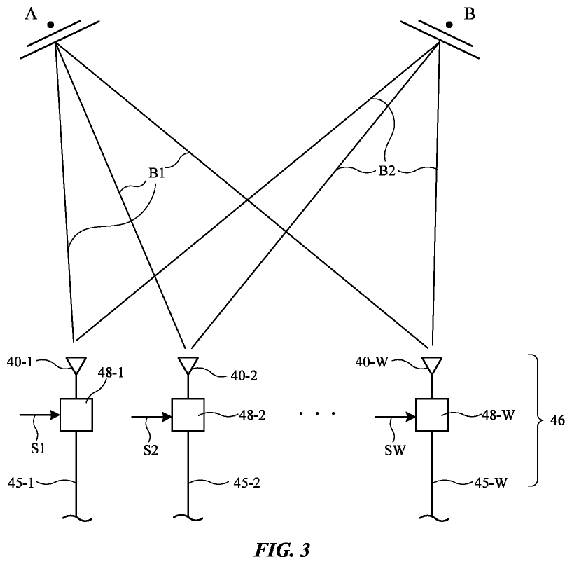

FIG. 3 shows how multiple antennas 40 may form part of a phased antenna array 46. As shown in FIG. 3, phased antenna array 46 (sometimes referred to herein as array 46, antenna array 46, or array 46 of antennas 40) may be coupled to radio-frequency transmission lines 45 (e.g., signal paths in communication path 44 of FIG. 2). For example, a first antenna 40-1 in phased antenna array 46 may be connected to a first radio-frequency transmission line 45-1, a second antenna 40-2 in phased antenna array 46 may be connected to a second radio-frequency transmission line 45-2, a Wth antenna 40-W in phased antenna array 46 may be connected to a Wth radio-frequency transmission line 45-W, etc. While antennas 40 are described herein as forming a phased antenna array, the antennas 40 in phased antenna array 46 may sometimes also be referred to as collectively forming a single phased array antenna (e.g., where antennas 40 form antenna elements of the phased array antenna).

Antennas 40 in phased antenna array 46 may be arranged in any desired number of rows and columns or in any other desired pattern (e.g., the antennas need not be arranged in a grid pattern having rows and columns). Each antenna 40 may be separated from one or more adjacent antennas 40 in phased antenna array 46 by a predetermined distance such as approximately half an effective wavelength of operation of the array. During signal transmission operations, radio-frequency transmission lines 45 may be used to supply signals (e.g., radio-frequency signals such as millimeter wave, centimeter wave, and/or sub-THz signals) from transceiver circuitry 42 (FIG. 2) to phased antenna array 46 for wireless transmission. During signal reception operations, radio-frequency transmission lines 45 may be used to supply signals received at phased antenna array 46 (e.g., from external wireless equipment or transmitted signals that have been reflected off of external objects) to transceiver circuitry 42.

The use of multiple antennas 40 in phased antenna array 46 allows beam forming/steering arrangements to be implemented by controlling the relative phases and magnitudes (amplitudes) of the radio-frequency signals conveyed by the antennas. In the example of FIG. 3, antennas 40 each have a corresponding radio-frequency phase and magnitude controller 48 (e.g., a first phase and magnitude controller 48-1 interposed on radio-frequency transmission line 45-1 may control phase and magnitude for radio-frequency signals handled by antenna 40-1, a second phase and magnitude controller 48-2 interposed on radio-frequency transmission line 45-2 may control phase and magnitude for radio-frequency signals handled by antenna 40-2, a Wth phase and magnitude controller 48-W interposed on radio-frequency transmission line 45-W may control phase and magnitude for radio-frequency signals handled by antenna 40-W, etc.).

Phase and magnitude controllers 48 may each include circuitry for adjusting the phase of the radio-frequency signals on radio-frequency transmission lines 45 (e.g., phase shifter circuits) and/or circuitry for adjusting the magnitude of the radio-frequency signals on radio-frequency transmission lines 45 (e.g., power amplifier and/or low noise amplifier circuits). Phase and magnitude controllers 48 may sometimes be referred to collectively herein as beam steering circuitry or beam forming circuitry (e.g., beam steering/forming circuitry that steers/forms the beam of radio-frequency signals transmitted and/or received by phased antenna array 46).

Phase and magnitude controllers 48 may adjust the relative phases and/or magnitudes of the transmitted signals that are provided to each of the antennas in phased antenna array 46 and may adjust the relative phases and/or magnitudes of the received signals that are received by phased antenna array 46. Phase and magnitude controllers 48 may, if desired, include phase detection circuitry for detecting the phases of the received signals that are received by phased antenna array 46. The term “beam” or “signal beam” may be used herein to collectively refer to wireless signals that are transmitted and/or received by phased antenna array 46 in a particular direction. Each beam may exhibit a peak gain that is oriented in a respective beam pointing direction at a corresponding beam pointing angle (e.g., based on constructive and destructive interference from the combination of signals from each antenna in the phased antenna array). Different sets of phase and magnitude settings for phase and magnitude controllers 48 may configure phased antenna array 46 to form different beams in different beam pointing directions.

If, for example, phase and magnitude controllers 48 are adjusted to produce a first set of phases and/or magnitudes, the signals will form a beam as shown by beam B1 of FIG. 3 that is oriented in the direction of point A. If, however, phase and magnitude controllers 48 are adjusted to produce a second set of phases and/or magnitudes, the signals will form a beam as shown by beam B2 that is oriented in the direction of point B. Each phase and magnitude controller 48 may be controlled to produce a desired phase and/or magnitude based on a corresponding control signal S received from control circuitry 38 of FIG. 2 (e.g., the phase and/or magnitude provided by phase and magnitude controller 48-1 may be controlled using control signal 51, the phase and/or magnitude provided by phase and magnitude controller 48-2 may be controlled using control signal S2, the phase and/or magnitude provided by phase and magnitude controller 48-W may be controlled using control signal SW, etc.). If desired, the control circuitry may actively adjust control signals S in real time to steer (form) the beam in different desired directions over time. Phase and magnitude controllers 48 may provide information identifying the phase of received signals to control circuitry 38 if desired.

When performing wireless communications using radio-frequency signals at relatively high frequencies such as millimeter and centimeter wave frequencies, radio-frequency signals are conveyed over a line-of-sight path between phased antenna array 46 and external communications equipment. If the external equipment is located at point A of FIG. 3, phase and magnitude controllers 48 may be adjusted to steer the signal beam towards point A (e.g., to steer the pointing direction of the signal beam towards point A). Phased antenna array 46 may transmit and receive radio-frequency signals in the direction of point A. Similarly, if the external equipment is located at point B, phase and magnitude controllers 48 may be adjusted to steer the signal beam towards point B (e.g., to steer the pointing direction of the signal beam towards point B). Phased antenna array 46 may transmit and receive radio-frequency signals in the direction of point B.

In the example of FIG. 3, beam steering is shown as being performed over a single degree of freedom for the sake of simplicity (e.g., towards the left and right on the page of FIG. 3). However, in practice, the beam may be steered over two or more degrees of freedom (e.g., in three dimensions, into and out of the page and to the left and right on the page of FIG. 3). Phased antenna array 46 may have a corresponding field of view over which beam steering can be performed (e.g., in a hemisphere or a segment of a hemisphere over the phased antenna array).

If desired, device 10 may include multiple phased antenna arrays 46 that each face a different direction to provide wireless coverage from multiple sides of the device. Each phased antenna array 46 may be formed as a part of a respective antenna module within device 10. If desired, multiple phased antenna arrays 46 may be disposed on a single antenna module and/or a single phased antenna array 46 may be distributed across two or more antenna modules. The antenna modules may be disposed at different locations on device 10 for providing a full sphere of beam coverage around device 10.

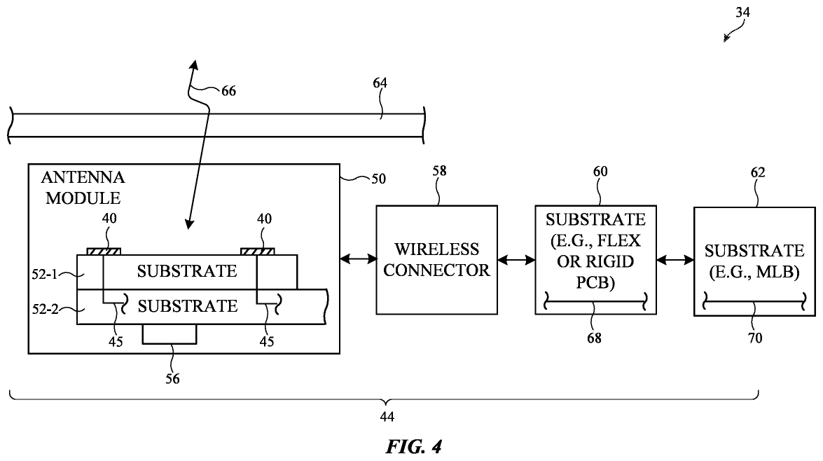

Communication path 44 (FIG. 2) may communicably couple baseband circuitry 36 to a given antenna module in device 10 (e.g., the antenna module may be fed by communication path 44). The communication path may extend across multiple substrates in device 10. FIG. 4 is a diagram showing one example of how an antenna module may be fed by communication path 44.

As shown in FIG. 4, wireless circuitry 34 may include an antenna module 50 (sometimes referred to herein as antenna package 50, antenna-in-package 50, antenna panel 50, or antenna assembly 50). Antenna module 50 may include one or more substrates 52. Each substrate 52 may include, for example, a rigid printed circuit board (e.g., having stacked dielectric layers of rigid printed circuit board material), a flexible printed circuit (e.g., having stacked dielectric layers of flexible printed circuit material such as polyimide or liquid crystal polymer), a ceramic substrate, a plastic substrate, or other substrates.

One or more antennas 40 may be disposed on, mounted to, or integrated (embedded) within one or more of the substrates 52 of antenna module 50. One or more signal paths in communication path 44 (e.g., radio-frequency transmission lines that convey radio-frequency signals or intermediate frequency signals and/or baseband paths) may be disposed on and/or embedded within one or more of the substrates 52 of antenna module 50 and may be coupled to the one or more antennas 40 in antenna module 50. The signal paths may include conductive traces on one or more layers of the one or more substrates 52 and/or conductive vias extending through one or more of the layers of the one or more substrates 52, for example.

The antenna(s) 40 in antenna module 50 may transmit radio-frequency signals 66 through dielectric cover layer 64 in device 10 and/or may receive radio-frequency signals 66 through dielectric cover layer 64. The antenna(s) 40 in antenna module 50 may receive the radio-frequency signals for transmission through dielectric cover layer 64 from the signal path(s) on substrate(s) 52 of antenna module 50. Conversely, the antenna(s) 40 in antenna module 50 may pass the radio-frequency signals received through dielectric cover layer 64 onto the signal path(s) on substrate(s) 52 of antenna module 50. Dielectric cover layer 64 may, for example, be a dielectric cover layer in/on rear housing wall 12R (FIG. 1), a display cover layer for display 14 (FIG. 1), or a dielectric antenna window disposed in peripheral conductive housing structures 12 W (FIG. 1).

As shown in the example of FIG. 4, antenna module 50 may, if desired, include at least a first substrate 52-1 (e.g., a rigid printed circuit or ceramic substrate) having one or more antennas 40 disposed thereon and may include a second substrate 52-2 (e.g., a flexible printed circuit) mounted to first substrate 52-1. The antennas 40 on substrate 52-1 may include a single antenna 40 (e.g., an antenna that is not part of a phased antenna array) or may include multiple antennas 40 (e.g., the antennas 40 in antenna module 50 may form a corresponding phased antenna array 46 of FIG. 3, the antennas 40 in antenna module 50 may form part of a phased antenna array 46 that also includes antennas external to antenna module 50, or the antennas 40 in antenna module 50 may form multiple different phased antenna arrays 46).

Antenna module 50 may include signal paths such as radio-frequency transmission line paths 45. Radio-frequency transmission line paths 45 may extend through substrate 52-1 and/or 52-2. If desired, antenna module 50 may include one or more radio-frequency components 56 mounted to one or more of the substrates 52 in antenna module 50 (e.g., surface-mounted to substrate 52-2). Radio-frequency components 56 may include phase and magnitude controllers 48 (FIG. 3) for the antennas 40 in antenna module 50, radio-frequency front end circuitry (e.g., one or more radio-frequency front end modules), switching circuitry, filter circuitry, impedance matching circuitry, tuning circuitry (e.g., one or more tuners), transceiver circuitry (e.g., for converting between intermediate frequency signals and radio-frequency signals, from converting between intermediate frequency signals and baseband signals, or for converting between radio-frequency signals and baseband signals), and/or any other desired radio-frequency circuitry.

If desired, some or all of radio-frequency components 56 may be integrated into one or more radio-frequency integrated circuits (RFICs) mounted to or integrated within antenna module 50. In implementations where antenna module 50 includes radio-frequency components 56, transmission line paths 45 may couple the antenna(s) 40 in antenna module 50 to radio-frequency components 56 and additional signal paths in antenna module 50 (e.g., radio-frequency transmission line paths or baseband paths) may couple radio-frequency components 56 to the remainder of communication path 44 (e.g., to baseband circuitry 36 through the remainder of communication path 44).

Communication path 44 may include the signal paths in antenna module 50 (e.g., radio-frequency transmission line paths 45 and/or additional signal paths coupled to radio-frequency components 56), one or more signal paths in another substrate such as substrate 60, and one or more signal paths in another substrate such as substrate 62. As shown in FIG. 4, substrate 60 may include signal paths 68 (e.g., radio-frequency transmission line paths and/or baseband paths). Substrate 60 may include a rigid printed circuit board, a flexible printed circuit, or another substrate. Signal paths 68 may include conductive traces and/or conductive vias on and/or extending through one or more dielectric layers in substrate 60.

Similarly, substrate 62 may include signal paths 70 (e.g., radio-frequency transmission line paths and/or baseband paths). Substrate 62 may include a rigid printed circuit board, a flexible printed circuit, a logic board, or another substrate. In one implementation that is described herein as an example, substrate 62 is a main logic board (MLB) for device 10. Signal paths 70 may include conductive traces and/or conductive vias on and/or extending through one or more dielectric layers in substrate 62.

The signal paths in substrate 62, substrate 60, and antenna module 50 may be coupled together by interconnect structures to form a single communication path 44 between the antenna(s) 40 in antenna module 50 and baseband circuitry 36 (FIG. 2). Baseband circuitry 36 may be disposed on substrate 62, on substrate 60, or on antenna module 50. When baseband circuitry 36 is disposed on substrate 62, transceiver circuitry 42 (FIG. 2) may be disposed on substrate 62, substrate 60, and/or antenna module 50. When baseband circuitry 36 is disposed on substrate 60, transceiver circuitry 42 (FIG. 2) may be disposed on substrate 60 or antenna module 50. When baseband circuitry 36 is disposed on antenna module 50, transceiver circuitry 42 (FIG. 2) may also be disposed on antenna module 50 and the baseband circuitry may receive control signals or other baseband signals from other circuitry (e.g., portions of control circuitry 38 of FIG. 2) via the signal paths on substrates 60 and 62. As such, any of the signal paths on antenna module 50, substrate 60, and substrate 62 may convey baseband signals, intermediate-frequency signals, or radio-frequency signals (sometimes referred to collectively herein simply as signals or communication signals). Substrate 62 may be omitted from communication path 44 if desired.

Communication path 44 may include a board-to-board (B2B) connector that couples the signal paths 68 on substrate 60 to the signal paths 68 on substrate 60. Communication path 44 may also include a B2B connector that couples signal paths 68 on substrate 60 to the signal paths on antenna module 50. The B2B connectors may also help to mechanically couple substrate 62 to substrate 60 (e.g., to ensure a reliable and robust connection between the signal paths on each substrate during operation of device 10). Such B2B connectors include physical (wired) connections (e.g., galvanic contacts) between the signal paths on two substrates. However, these types of B2B connectors can introduce undesired impedance discontinuities to communication path 44 (e.g., causing unwanted signal reflections between substrates, particularly given the high frequencies that would be conveyed over the connectors), can undesirably increase insertion loss, can be difficult to electromagnetically isolate, can exhibit limited bandwidth, and can suffer from mechanical reliability issues during the lifetime of device 10.

To mitigate or eliminate the insertion loss, isolation issues, limited bandwidth, and reliability concerns associated with physical B2B connectors, communication path 44 may include wireless connectors between two or more of the substrates in communication path 44, such as wireless connector 58. Wireless connector 58 may communicably couple the signal paths on antenna module 50 to signal paths 68 on substrate 60. Rather than utilizing conductive contacts or a galvanic connection, wireless connector 58 may wirelessly convey signals (e.g., over-the-air) between the signal paths on antenna module 50 and signal paths 68 on substrate 60. While an implementation in which wireless connector 58 is used to couple substrate 60 to antenna module 50 is described herein as an example, wireless connector 58 may additionally or alternatively be used to couple signal paths 68 on substrate 60 to signal paths 70 on substrate 62.

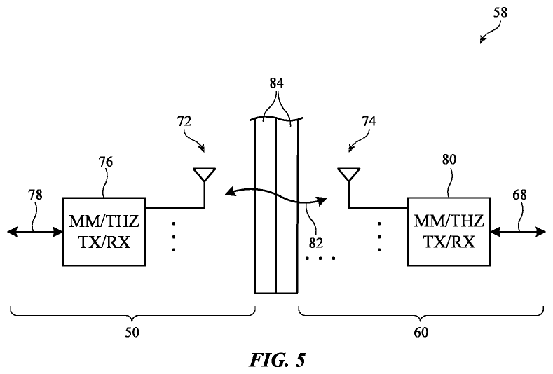

FIG. 5 is a diagram of wireless connector 58. As shown in FIG. 5, a first portion of wireless connector 58 (e.g., first wireless connector structures) may be disposed on antenna module 50 (e.g., substrate 52-2 or another substrate 52). A second portion of wireless connector 58 (e.g., second wireless connector structures) may be disposed on substrate 60.

The first portion of wireless connector 58 may include a first transceiver 76 (sometimes referred to herein as connector transceiver 76 or data transceiver 76) and one or more antennas 72 coupled to transceiver 76. Transceiver 76 may be mounted to (e.g., surface-mounted) or embedded within one of the substrates 52 in antenna module 50. Transceiver 76 may also be coupled to one or more signal paths 78 on antenna module 50 (e.g., radio-frequency transmission line paths 45 and/or signal paths coupled to radio-frequency components 56 of FIG. 4, which may be radio-frequency transmission line paths and/or baseband paths). Antennas 72 may include a single antenna or multiple antennas. If desired, multiple antennas 72 may be arranged into a phased antenna array (e.g., phased antenna array 46 of FIG. 2).

The second portion of wireless connector 58 may include a second transceiver 80 (sometimes referred to herein as connector transceiver 80 or data transceiver 80) and one or more antennas 74 coupled to transceiver 80. Transceiver 80 may be mounted to (e.g., surface-mounted) or embedded within substrate 60. Transceiver 80 may also be coupled to one or more signal paths 68 on substrate 60 (e.g., radio-frequency transmission line paths and/or baseband paths paths). Antennas 74 may include a single antenna or multiple antennas. If desired, multiple antennas 74 may be arranged into a phased antenna array (e.g., phased antenna array 46 of FIG. 2).

Antennas 72 and 74 may sometimes be referred to herein as antenna elements. Antennas 72 and 74 may be formed using any desired antenna structures for conveying wireless radio-frequency signals. For example, antennas 72 and 74 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, filter circuitry, switching circuitry, impedance matching circuitry, and/or other antenna tuning components may be adjusted to adjust the frequency response and wireless performance of antennas 72 and 74 over time.

During data transfer (e.g., wireless communications), wireless connector 58 may convey wireless signals 82 between antenna(s) 72 and antenna(s) 74. During signal transmission over communication path 44 (FIG. 4), transceiver 80 may receive signals over signal path(s) 68 (e.g., intermediate frequency signals, baseband signals, or radio-frequency signals, which may include wireless data for transmission to an external device using the antenna module, waveforms for spatial ranging signals, or other signal modulations). Transceiver 80 may transmit the signals using antenna(s) 74 (as wireless signals 82). If desired, transceiver 80 may up-convert the signals received on signal path(s) 68 (e.g., from baseband to radio frequencies, from intermediate frequencies to radio frequencies, or from first radio frequencies to second (higher) radio frequencies). The wireless signals 82 transmitted by transceiver 80 and antenna(s) 74 may be at relatively high frequencies such as cm wave frequencies, mm wave frequencies, or sub-THz frequencies (e.g., between 10 GHz and 1000 GHz, between 100 GHz and 1000 GHz, between 60 GHz and 1000 GHz, etc.), which serves to maximize the data rate supported by wireless connector 58.

Antenna(s) 72 may receive wireless signals 82 and may pass the signals to transceiver 76 (e.g., transceiver 76 may receive wireless signals 82 using antenna(s) 72). Transceiver 76 may transmit the signals received using antenna(s) 72 over signal path(s) 78 (e.g., as radio-frequency signals, intermediate frequency signals, or baseband signals). If desired, transceiver 76 may down-convert the signals received using antenna(s) 72 to help minimize signal attenuation along the remainder of the communication path (e.g., from the radio frequencies of wireless signals 82 to lower radio frequencies, from radio frequencies to intermediate frequencies, from radio frequencies to baseband, etc.). Alternatively, if desired, transceiver 76 may up-convert the signals received using antenna(s) 72 (e.g., from the radio frequencies of wireless signals 82 to higher radio frequencies for transmission over the antenna(s) 40 in antenna module 50). Signal path(s) 78 may pass the signals to radio-frequency components 56 (FIG. 4), which pass the signals to antenna(s) 40 via radio-frequency transmission line path(s) 45, and/or signal path(s) 78 may pass the signals to antenna(s) 40 in antenna module 50.

During signal reception using communication path 44 (FIG. 4), transceiver 76 may receive signals over signal path(s) 78 (e.g., intermediate frequency signals, baseband signals, or radio-frequency signals, which may include wireless data received from an external device using the antenna module, reflected waveforms from transmitted spatial ranging signals, or other signal modulations). Transceiver 76 may transmit the signals using antenna(s) 72 (as wireless signals 82). If desired, transceiver 76 may up-convert the signals received on signal path(s) 78 (e.g., from baseband to radio frequencies, from intermediate frequencies to radio frequencies, or from first radio frequencies to second radio frequencies that are higher than the first radio frequencies). Alternatively, if desired, transceiver 76 may down-convert the signals received on signal path(s) 78 (e.g., from first radio frequencies used by antenna(s) 40 to lower radio frequencies used by antennas 72 and 74).

Antenna(s) 74 may receive wireless signals 82 and may pass the signals to transceiver 80 (e.g., transceiver 80 may receive wireless signals 82 using antenna(s) 74). Transceiver 80 may transmit the signals received using antenna(s) 74 over signal path(s) 68. If desired, transceiver 80 may down-convert the signals received using antenna(s) 74 to help minimize signal attenuation along the remainder of the communication path (e.g., from the radio frequencies of wireless signals 82 to lower radio frequencies, from radio frequencies to intermediate frequencies, from radio frequencies to baseband, etc.). Alternatively, if desired, transceiver 80 may up-convert the signals received using antenna(s) 72 (e.g., from the radio frequency of wireless signals 82 to higher radio frequencies). Signal path(s) 68 may pass the signals to signal traces 70 on substrate 62, which pass the signals to baseband circuitry 34 at the termination of communication path 44. If desired, transceiver 76 and/or transceiver 80 may form part of transceiver circuitry 42 of FIG. 2 (e.g., as part of one or more cellular telephone transceiver chips).

As shown in FIG. 5, antennas 72 and 74 may be separated by a gap (e.g., an air gap). If desired, wireless connector 58 may include one or more dielectric matching layers such as dielectric layers 84 disposed in the gap between antennas 72 and 74. Dielectric layer(s) 84 may help to form an impedance transition (at the frequencies of wireless signals 82) from antenna(s) 72 to antenna(s) 74, thereby minimizing loss between antennas 72 and 74 and maximizing the efficiency of communication path 44 relative to implementations where there is simply an impedance transition from antennas 72/74 to air at the gap.

Dielectric layer(s) 84 may, for example, include relatively high dielectric constant material such as zirconia, sapphire, or liquid crystal. If desired, different dielectric layers 84 may have different dielectric constants to help form a smooth impedance transition across the gap (e.g., from low-to-high, from high-to-low, from low-to-high and high-to-low, or from high-to-low and low-to-high from antenna(s) 72 to antenna(s) 74). Dielectric layers 84 may be layered onto substrate 60 and/or antenna module 50 or may, if desired, be floating between (e.g., without contacting) antenna module 50 and substrate 60.

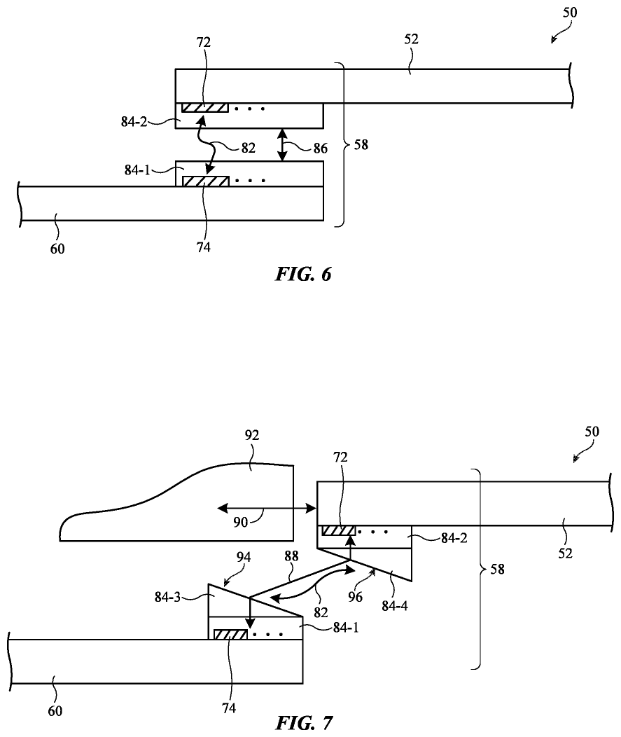

Antennas 72 may be aligned with antennas 74 at wireless connector 58 or may be offset with respect to each other at wireless connector 58. FIG. 6 is a diagram showing one example of how antennas 72 may be aligned with antennas 74 at wireless connector 58. As shown in FIG. 6, one of the substrates 52 of antenna module 50 may at least partially overlap substrate 60 (e.g., an end of substrate 60 may overlap an end of substrate 52). Wireless connector 58 may couple signal paths 68 (FIG. 5) on substrate 60 to signal paths 78 (FIG. 5) on substrate 52. Signal paths 78 and 68 and transceivers 76 and 80 of FIG. 5 have been omitted from FIGS. 6 and 7 for the sake of clarity.

As shown in FIG. 6, the antenna(s) 72 in wireless connector 58 may be disposed on, mounted to, or embedded within substrate 52. The antenna(s) 74 in wireless connector 58 may be disposed on, mounted to, or embedded within substrate 60. The antenna(s) 72 in wireless connector 58 may be aligned with or overlapping the antenna(s) 74 in wireless connector 58. Wireless connector 58 may include at least dielectric layer 84-1 and dielectric layer 84-2 in the gap between antennas 72 and 74. Dielectric layer 84-1 may, for example, be layered onto substrate 60 overlapping antenna(s) 74 whereas dielectric layer 84-2 is layered onto substrate 52 overlapping antenna(s) 72. If desired, an air gap 86 may be present between the dielectric layer(s) 84 on substrate 60 and the dielectric layer(s) 84 on substrate 52. Alternatively, dielectric layers 84 may fill an entirety of the gap between substrates 60 and 52 such that wireless connector 58 includes no air gap 86 (e.g., a continuous stack of dielectric layers 84 may be disposed between substrate 60 and substrate 52).

Antenna(s) 72 and/or antenna(s) 74 may transmit wireless signals 82 across the gap between substrates 60 and 52 (e.g., through dielectric layer(s) 84). Dielectric layers 84-1 and 84-2 (and any other dielectric layers 84 included in wireless connector 58) may help to form a smooth impedance transition from antenna(s) 74 to antenna(s) 72 at the frequency of wireless signals 82 (even in implementations where air gap 86 is present).

FIG. 7 is a diagram showing one example of how antennas 72 may be offset with respect to antennas 74 at wireless connector 58. As shown in FIG. 7, substrate 52 and antenna(s) 72 may be offset (displaced) from substrate 60 and antenna(s) 74 by distance 90 (sometimes referred to herein as displacement 90, margin 90, or offset 90). A portion of substrate 52 may still overlap a portion of substrate 60 or substrates 52 and 60 may be non-overlapping. Offsetting substrate 52 in this way may accommodate the presence of one or more other components 92 in device 10 (e.g., within the space spanned by distance 90), thereby allowing the communication path to be distributed across different regions of device 10 that may have other requirements or space constraints for disposing other components.

As shown in FIG. 7, the dielectric layers 84 in wireless connector 58 may include at least an angled layer 84-3 on substrate 60 (overlapping antenna(s) 74) and an angled layer 84-4 on substrate 52 (overlapping antenna(s) 72). Angled layer 84-3 may be layered, stacked, or mounted on top one or more underlying dielectric layers 84 such as dielectric layer 84-1 or may be layered, stacked, or mounted directly onto the lateral surface of substrate 60. Similarly, angled layer 84-4 may be layered, stacked, or mounted on top one or more underlying dielectric layers 84 such as dielectric layer 84-2 or may be layered, stacked, or mounted directly onto the lateral surface of substrate 52. Angled layer 84-3 may, if desired, form an outermost dielectric layer 84 overlapping antenna(s) 74 and angled layer 84-2 may, if desired, form an outermost dielectric layer 84 overlapping antenna(s) 72 in wireless connector 58.

Angled layer 84-3 may have a first surface mounted to substrate 60 or the underlying dielectric layer 84. Angled layer 84-3 may have a second surface 94 opposite the first surface (sometimes referred to herein as angled surface 94 or exit face 94). The first surface may be oriented parallel to the lateral surface of substrate 60. Angled surface 94 may be oriented at a non-parallel angle with respect to the first surface. Angled surface 94 may, for example, be tilted towards angled layer 84-4 on substrate 52 (e.g., such that a normal vector of angled surface 94 points towards angled layer 84-4).

Similarly, angled layer 84-4 may have a first surface mounted to substrate 52 or the underlying dielectric layer 84. Angled layer 84-4 may have a second surface 96 opposite the first surface (sometimes referred to herein as angled surface 96 or exit face 96). The first surface may be oriented parallel to the lateral surface of substrate 52. Angled surface 96 may be oriented at a non-parallel angle with respect to the first surface. Angled surface 96 may, for example, be tilted towards angled layer 84-3 on substrate 60 (e.g., such that a normal vector of angled surface 96 points towards angled layer 84-3). If desired, angled surface 96 may be parallel to angled surface 94.

Angled layers 84-3 and 84-4 may help to direct wireless signals 82 between antenna(s) 72 and antenna(s) 74 despite the offset between antenna(s) 72 and antenna(s) 74. For example, when antenna(s) 74 transmit wireless signals 82, angled layer 84-3 may serve to redirect wireless signals 82 towards angled surface 96 of angled layer 84-4 (e.g., via refraction), despite the offset between antenna(s) 72 and antenna(s) 74 (as shown by arrow 88). At the same time, angled layer 84-4 may serve to redirect wireless signals 82 incident from angled layer 84-3 upwards (e.g., via refraction) towards the overlapping antenna(s) 72 (as shown by arrow 88). Conversely, when antenna(s) 72 transmit wireless signals 82, angled layer 84-4 may serve to redirect wireless signals 82 towards angled surface 94 of angled layer 84-3 (as shown by arrow 88). At the same time, angled layer 84-3 may serve to redirect wireless signals 82 incident from angled layer 84-4 downwards towards the overlapping/underlying antenna(s) 74 (as shown by arrow 88). In this way, the dielectric layers 84 in wireless connector 50 may serve to both form a smooth impedance transition between the antennas and to redirect wireless signals 82 to compensate for offsets or displacements between substrates 60 and 52 as required to accommodate components 92.

The example of FIG. 7 is illustrative and non-limiting. In implementations where antenna(s) 72/74 include arrays of antennas, each antenna may share the same angled layer (e.g., the angled layer may overlap every antenna of the array), each antenna may have its own respective angled layer (e.g., different angled layers may overlap each antenna of the array), or multiple antennas may share an angled layer (e.g., multiple angled layers may overlap different sets of antennas in the array). Angled surfaces 94 and 96 may be tilted in one or two dimensions (e.g., about one or two axes). If desired, angled surface 94 and/or 96 may be curved (e.g., spherically curved, freeform curved, curved about one or more axes, three-dimensionally curved, etc.) or may have any other desired shapes (e.g., for redirecting wireless signals 82 in corresponding directions and/or for forming a smooth impedance transition between the antennas).

The example described herein in which communication path 44 couples baseband circuitry 36 to antennas 40 (FIG. 1) is illustrative and non-limiting. In general, communication path 44 may be any desired signal path or data path in device 10 (e.g., for coupling any two components together). As such, wireless connector 58 may be used to wirelessly convey any desired signals containing any desired data between any desired signal traces on any desired substrates in device 10. Wireless connector 58 may sometimes be referred to herein as a wireless data connector.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent with.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. An electronic device comprising:
a first substrate having a first signal trace;
a second substrate having a second signal trace; and
a wireless connector that communicably couples the first signal trace to the second signal trace, the wireless connector including
a first antenna on the first substrate,
a second antenna on the second substrate, and
one or more dielectric matching layers disposed between the first antenna and the second antenna.

2. The electronic device of claim 1, wherein the one or more dielectric matching layers comprise:
a first dielectric matching layer on the first substrate and overlapping the first antenna.

3. The electronic device of claim 2, wherein the one or more dielectric matching layers comprise:
a second dielectric matching layer on the second substrate and overlapping the second antenna.

4. The electronic device of claim 3, further comprising an air gap between the first dielectric matching layer and the second dielectric matching layer.

5. The electronic device of claim 3, wherein the one or more dielectric matching layers further comprise:
a first angled layer on the first dielectric matching layer.

6. The electronic device of claim 5, wherein the one or more dielectric matching layers further comprise:
a second angled layer on the first dielectric matching layer, wherein the first angled layer has a first angled face that points towards the second angled layer and the second angled layer has a second angled face that points towards the first angled layer.

7. The electronic device of claim 1, wherein the one or more dielectric matching layers comprises a stack of dielectric matching layers extending continuously from the first substrate to the second substrate and overlapping the first antenna.

8. The electronic device of claim 1, wherein the one or more dielectric matching layers comprises:
a first dielectric matching layer on the first substrate and overlapping the first antenna, wherein the first dielectric matching layer has a first surface and a second surface opposite the first surface, the first surface faces the first substrate and extends parallel to a lateral surface of the first substrate, and the second surface is oriented at a non-parallel angle with respect to the first surface.

9. The electronic device of claim 8, wherein the one or more dielectric matching layers comprises:
a second dielectric matching layer on the second substrate and overlapping the second antenna, wherein the second dielectric matching layer has a third surface and a fourth surface opposite the third surface, the third surface faces the second substrate and extends parallel to a lateral surface of the second substrate, and the fourth surface is oriented at a non-parallel angle with respect to the third surface.

10. The electronic device of claim 9, wherein the first surface is on the lateral surface of the first substrate and the third surface is on the lateral surface of the second substrate.

11. The electronic device of claim 1, the wireless connector further comprising:
a first transceiver on the first substrate and coupled to the first antenna and the first signal trace;
a third antenna on the first substrate and coupled to the first transceiver;
a second transceiver on the second substrate and coupled to the second antenna and the second signal trace; and
a fourth antenna on the second substrate and coupled to the second transceiver, wherein the first antenna and the third antenna are configured to transmit, to the third antenna and the fourth antenna and through the one or more dielectric matching layers, wireless signals that include data conveyed over the first signal trace.

12. An electronic device comprising:
a first printed circuit board having a first signal path;
a first transceiver on the first printed circuit board and coupled to the first signal path;
a second printed circuit board having a second signal path;
a second transceiver on the second printed circuit board and coupled to the second signal path;
a first antenna coupled to the first transceiver, the first antenna being disposed on the first printed circuit;
a second antenna coupled to the second transceiver, the second antenna being disposed on the second printed circuit board and being laterally offset with respect to the first antenna; and
a dielectric layer overlapping the first antenna, wherein the dielectric layer has a first surface facing the first printed circuit board and a second surface opposite the first surface, that second surface being non-parallel with respect to the first surface.

13. The electronic device of claim 12, wherein the second surface is angled towards the second antenna.

14. The electronic device of claim 13, further comprising:
an additional dielectric layer overlapping the second antenna, wherein the additional dielectric layer has a third surface facing the second printed circuit board and a fourth surface opposite the second surface, that fourth surface being non-parallel with respect to the third surface.

15. The electronic device of claim 14, wherein the third surface is angled towards the first antenna.

16. The electronic device of claim 12, wherein the first printed circuit board comprises a rigid printed circuit board and the second printed circuit board comprises a flexible printed circuit board.

17. The electronic device of claim 12, wherein the first printed circuit board and the second printed circuit board are non-overlapping.

18. The electronic device of claim 12, further comprising:
a third antenna mounted to the first printed circuit board and communicably coupled to the first signal trace; and
baseband circuitry communicably coupled to the second signal trace.

19. An electronic device comprising:
a dielectric cover layer;
a substrate having a first signal path;
a phased antenna array on the substrate, coupled to the first signal path, and configured to radiate through the dielectric cover layer;
a flexible printed circuit having a second signal path; and
a wireless connector having
a first transceiver on the substrate and coupled to the first signal path,
a first antenna coupled to the first transceiver,
a second transceiver on the flexible printed circuit and coupled to the second signal path, and
a second antenna coupled to the second transceiver, the first antenna and the second antenna being configured to wirelessly convey data between the first signal path and the second signal path.

20. The electronic device of claim 19, wherein the wireless connector comprises:
one or more dielectric layers disposed between the first antenna and the second antenna and configured to form an impedance transition for the wireless signals between the first antenna and the second antenna.
